(19) United States
(12) Patent Application Publication
(10) Pub. No.: US 2008/0024676 A1
(43) Pub. Date: Jan. 31, 2008

(54) Audio/video signal auto switching system

(76) Inventor: Hsi-Tung Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/727,664

(22) Filed: Mar. 28, 2007

(30) Foreign Application Priority Data
Jul. 28, 2006 (TW) 95213312

(51) Int. Cl. H04N 5/268

(52) U.S. Cl. 348/705; 348/E05.057

(57) ABSTRACT

Disclosed is an audio/video signal auto switching system. The system contains a last-on function block, a memory function block, a switch-back function block, and a memory-reset function block. If there is a plurality of input signals received by the system, then the last-on function block will select a last input signal as an output signal, and the memory function block will record the input sequence of the plurality of input signals. If a non-output signal disappears, the memory-reset function block will sort the input sequence. If the last input signal disappears, the switch-back function block will select the output signal from the plurality of the signals based on the input sequence.

### RELATED APPLICATIONS

The application claims priority to Taiwan Application Serial Number 95213312, filed Jul. 28, 2006, which is herein incorporated by reference.

### BACKGROUND

1. Field of Invention

The present invention relates to an audio/video signal switcher system. More particularly, the present invention relates to an audio/video signal auto switcher system.

2. Description of Related Art

The audio/video display devices (for example, LCD, and projector) display superior images, and output superior audio quality because of improvements in technology. Moreover, there is a wide variety of audio/video signal sources (for example, DVD player, and game console) and the audio/video signal source categories increase according to the varied function.

There is a plurality of input interfaces arranged on the display device to receive a variety of audio/video signal at the same time. For example, the TV could display the information from a variety of audio/video signals which selected by a remote control. However, the conventional input interfaces arranged on the display device are analog type. For transmitting a superior image and audio quality, and to reduce the interference and increase the transmission speed, digital signals are used to transmit audio/video data. For example, the High Definition Multimedia Interface (HDMI) is an all-digital audio/video interface capable of high speed digital data transmission with only one cable.

The cost of the control unit, and the digital interface are higher than the conventional analog interface. That is why there is usually only one input for each specific kind of digital interference on the common display device to receive the digital signal. Therefore, the audio/video switching apparatus is provided to connect a plurality of audio/video signal sources, and selects one of the audio/video signals from a plurality of audio/video signal sources to the display device. The conventional audio/video switching apparatus is controlled by the remote control to select the output signal. The user could be confused by the amount of remote controls when the user wants to adjust the parameter of the audio/video signal source and switch the output signal. Moreover, the user must remember the specific audio/video source corresponds to the input interface of the switching apparatus, otherwise, the user selects the specific audio/video source randomly or in sequence. The inconvenient switching method wastes the user's time and troubles the users.

Therefore, it is desirable to improve the audio/video switching apparatus that the user without remembering the specific audio/video source correspond to the input interface of the switching apparatus, and the user can switch the output signal easily and conveniently.

### SUMMARY

The current embodiment describes an audio/video auto switching system for receiving a plurality of input signals and selecting an output signal from a plurality of input signals based on an input sequence, the system comprises a last-on function block, a memory function block, a switch-back function block, and a memory-reset function block. The last-on function block clocked scans the plurality of input signals and selects a last input signal of the plurality of input signals as the output signal. The memory function block records the input sequence of the plurality of input signals. The switch-back function block is capable of selecting the output signal from the plurality of input signals based on the input sequence when the last input signal disappears. The memory-reset function block sorts the input sequence, when a non-output signal of the plurality of input signals disappears.

The embodiment of the invention applying the system described above to the HDMI switcher for receiving a plurality of input signals and selecting an output signal from the plurality of input signals. The HDMI switcher comprises at least one HDMI input interface, a control unit, an HDMI output interface. The control unit receives a plurality of input signals transmitted from the HDMI input interface. The HDMI output interface outputs the output signal selected from the control unit to a display device.

The control unit further comprises a plurality of function blocks that are a last-on function block, a memory function block, a switch-back function block, and a memory-reset function block. The last-on function block is capable of clocked scanning the plurality of input signals and selecting a last input signal of the plurality of input signals as the output signal. The memory function block records an input sequence of the plurality of input signals. The switch-back function block selects the output signal from the plurality of input signals based on the input sequence, when the last input signal of the plurality of input signals disappears. The memory-reset function block sorts the input sequence when a non-output signal of the plurality of input signals disappears.

### BRIEF DESCRIPTION OF THE DRAWINGS

These and other features, aspects, and advantages of the present invention will become better understood with regard to the following description, appended claims, and accompanying drawings where:

FIG. 1 is a schematic diagram of the system architecture for the embodiment of the present invention;

FIG. 2 is a schematic diagram of a flow chart of the embodiment of the present invention;

FIG. 3 is a schematic diagram of an HDMI switcher of the embodiment of the present invention;

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The following provides a detailed description of a system for auto switching audio/video signal. The version of the invention comprises a plurality of function blocks in the switching system. The system selects the last input signal as the output signal automatically, and records the input sequence of the plurality of the input signals. The input sequence is used for a reference when the system switches the output signal. Someone skilled in the art could change the application for other situations, and modify the parameters of the system and the manner of selecting the output signal for a variety of designs.

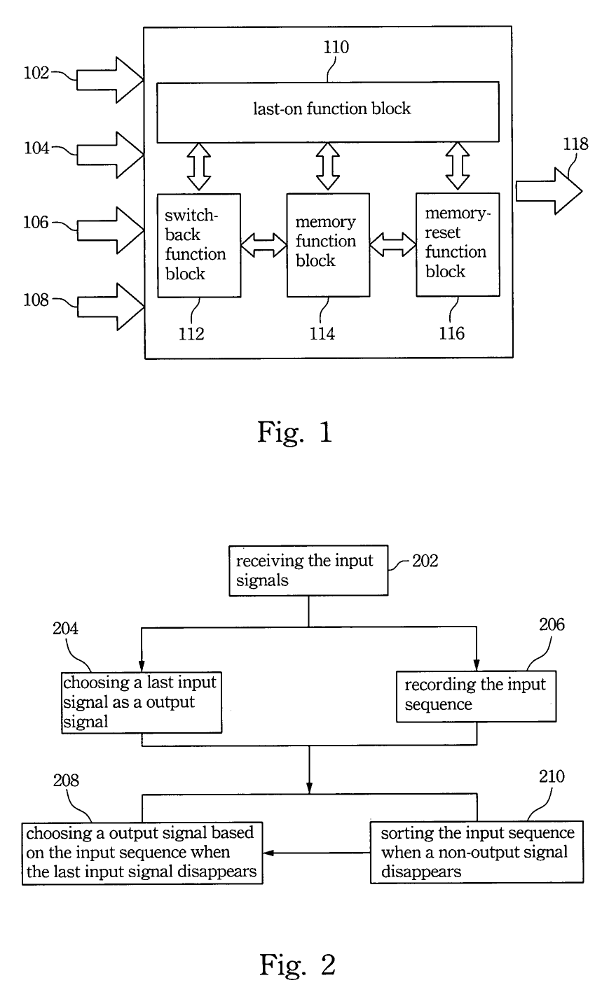

Please refer to FIG. 1. FIG. 1 is a schematic diagram of system architecture of the embodiment of the present invention. The system is composed of a last-on function block 110, a memory function block 114, a switch-back function block 112, and a memory-reset function block 116. The audio/video auto switching system could receive a plurality of input signals 102˜108, and select an output signal 118 based on an input sequence of the plurality of input signals 102˜108.

The last-on function block 110 clock scans the plurality of input signals 102˜108, and select a last input signal of the plurality of input signals 102˜108 as the output signal 118. The memory function block 114 records the input sequence of the plurality of input signals 102˜108. The switch-back function block 114 selects the output signal 118 based on the input sequence, when the last input signal of the plurality of input signals 102˜108 disappears. When a non-output signal of the plurality of signals 102˜108 disappears, the memory-reset function block 116 sorts the input sequence of the remaining input signals.

Moreover, the switch-back function block 112 selects a second to last input signal from the plurality of input signals 102˜108 as the output signal 118 based on the input sequence, when the last input signal disappears. The memory-reset function block 116 sorts the input sequence by an increasing/decreasing operation to prevent the system from being unable to select the output signal 118, when the non-output signal of the plurality of input signals disappears.

The last-on function block 110 has a highest selecting priority to select the output signal 118. Therefore, the user can instincly enjoy the sight of the information of the specific audio/video signals by turning on or resetting the specific audio/video signals source apparatus, because of the characteristic of the last-on function block 110.

Please refer to FIG. 2. FIG. 2 is a schematic diagram of a flow chart of the embodiment of the present invention. In step 202, the system clocked scans and receives a plurality of input signals. In step 204, the system selects a last input signal of the plurality of input signals as the output signal. In step 206, the system also records an input sequence of the plurality of input signals. In step 208, the system selects the output signal form the plurality of input signals based on the input sequence, when the last input signal of the plurality of input signals disappears. In step 210, the system sorts the input sequence when a non-output signal of the plurality of input signals disappears.

Wherein in the step 208, the system selects a second to last input signal from the plurality of input signals as the output signal based on the input sequence. Moreover, in step 210, sorting the input sequence requires performing an increasing/decreasing operation on the input sequence of the remaining input signals to fill a vacant position caused by the disappearance of the non-output signal to prevent a system error.

For details describing the application and advantages of the present invention, there is an embodiment that applies the system of this version of the invention to an HDMI switcher.

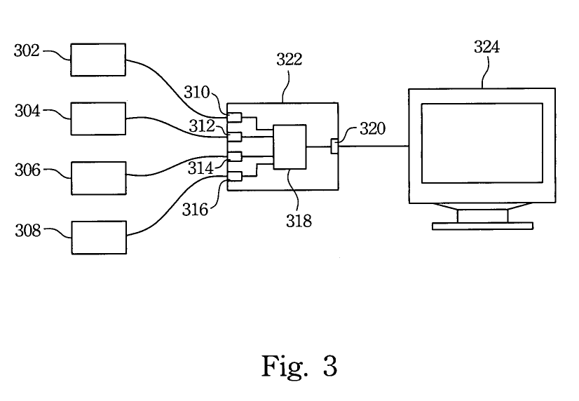

Please refer to FIG. 3. FIG. 3 is a schematic diagram of an HDMI switcher of the embodiment of the present invention. The HDMI switcher 322 receives a plurality of input signals and selects an output signal based on the input sequence of the plurality of input signals. The HDMI switcher 322 comprises a first audio/video signal source 302, a second audio/video signal source 304, a third audio/video signal source 306, a fourth audio/video signal source 308, a first HDMI input interface 310, a second HDMI input interface 312, a third HDMI interface 314, a fourth HDMI input interface 316, a control unit 318, an HDMI output interface 320, and a display device 324.

The control unit 318 receives a plurality of input signals transmitted from the HDMI input interface 310˜312, and selects an output signal from the plurality of input signals. The HDMI output interface 320 transmits the output signal selected by the control unit 318 to the display device 324. The control unit 318 further comprises a plurality of function blocks that are described above.

When turning on the HDMI switcher 322, the switcher 322 clocked scans the input interface 310˜316 to check whether the input interface 310˜316 receives an input signal or not. If the first audio/video signal source 302 is turned on, then the first signal of the first audio/video signal source 302 is transmitted to the control unit 318 through the first HDMI input interface 310. In this situation, the control unit 318 receives only one input signal, therefore, the last-on function block in the control unit 318 selects the first signal as the output signal, and the first signal is transmitted to the display device 324 through the HDMI output interface 320. The memory function block in the control unit 318 simultaneously remembers the first signal as a first input signal, and records a predetermined value for the first input signal in an input sequence. The embodiment of the invention assumes the predetermined value for the first input signal is 1.

Then the second audio/video signal source 304 is turned on after a short space of time. The switcher 322 receives a second signal of the second audio/video signal source 304, and the switcher 322 also receives the first signal at the same time. The switcher 322 receives the first and second signal simultaneously. In this situation, the last-on function block decides that the second signal is the last input signal, therefore, the last-on function block switches from the first signal to the second signal as the input signal. Also, the memory function block remembers the second signal as a second input signal, and records a predetermined value for the second input signal in the input sequence. The embodiment of the invention assumes the predetermined value for the second input signal is 2.

Subsequently, after a short space of time the third audio/video signal source 306 is turned on, and the switcher 322 receives the third signal of the third audio/video signal source 304. Therefore, the last-on function block switches from the second signal to the third signal as the input signal, and the memory function block remembers the third signal as a third input signal and records a predetermined value “3” in the input sequence for the third input signal. Finally, after a short space of time, the fourth audio/video signal source 308 is turned on, therefore, the switcher 322 outputs the fourth signal of the fourth audio/video signal source 308, and the memory function block remembers the fourth signal as a fourth input signal and records a predetermined value “4” in the input sequence for the fourth input signal.

Hence, the memory function block has the input sequence which contains the sequence of the input signal. If the fourth signal of the fourth audio/video signal disappears, then, the switch-back function block refers to the input sequence to determine the output signal. It is to be understood that the fourth signal corresponds to the value 4 in the input sequence. Therefore, the switch-back function block obtains the value 3 is the maximum value in the input sequence because the disappearance of the fourth signal. The switch-back function block is then outputs the third signal which corresponded to the value 3 in the input sequence. On the other hand, the switch-back function block could select a second to last input signal from the plurality of input signals as the output signal based on the input sequence, when the last input signal (such as the fourth signal in this embodiment) disappears.

In the situation that all audio/video signal sources 302˜308 are in the turned on mode, and the third signal disappears when the third audio/video signal source 306 is turned off suddenly, the input sequence is amended by the memory-reset function block. The memory-reset function block deletes the value 3 of the third signal, and sorts the input sequence. For example, in this embodiment, the memory-reset function block performs an increasing operation on the input sequence, that is, increasing the value corresponding to the first signal and the second signal. Therefore, the values of the first signal and the second signal are changed to 2 and 3 in the input sequence, thus, the memory-reset function block prevents the system error that the system cannot select the output signal because the input sequence has a vacant position.

The last-on function block has the highest selecting priority to select the output signal. Therefore, the user can instinctly enjoy the visual information of the specific audio/video signals by turning on or resetting the specific audio/video signals source apparatus. For example, in the situation that all audio/video signal sources 302˜308 are in the turned on mode, and the input signal is the fourth signal, if the user wants to switch from the fourth signal to the third signal as the output signal, then the user can turn off the third audio/video signal source first, and subsequently, turn on the third audio/video signal source 306. Therefore, the control unit 318 selects the third signal of the third audio/video signal source 306 as the input signal.

In addition, if the user wants to switch back to the fourth signal as the output signal, then the user instinctly turns on the fourth audio/video signal source 308. Therefore, the last-on function block scans the input interface which is connected to the fourth audio/video signal source 308, and receives the fourth signal. Then, the last-on function block switches to the fourth signal as the input signal, hence, the user can enjoy the visual information of the fourth audio/video source 308.

Furthermore, other than the increasing operation, input sequence can be sorted by the decreasing operation or other methods, where the methods are designed to adopt various input sequences. The action of recording and sorting the input sequence can prevent a system error where the system cannot select the output signal because the input sequence has a vacant position. The last-on function block in the system has the highest selecting priority to select the output signal, therefore the user can enjoy the visual information of the specific audio/video signals by instinctly turning on or resetting the specific audio/video signals source by instinct, that is making the specific audio/video signal as the last input signal.

As described above, the system of the embodiment of the invention can switch the audio/video signal automatically. Therefore, the system controls the signal switching without a remote control, and it can reduce the inconvenience of using the remote control and the risk of losing it. The user can instinctly turn on the audio/video signal source to enjoy the sight of the information on the screen. If there is a plurality of input signals received by the system, and the user wants to switch to a specific signal, then the user only resets the specific audio/video signal source. The system could select the last input signal as the output signal automatically. Therefore, the user without remembering the specific connector which connecting to the specific audio/video source, and the user can instinctly and conveniently switch the output signal.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An audio/video auto switching system for receiving a plurality of input signals and selecting an output signal from the plurality of input signals, the system comprises:
a last-on function block, capable of clocked scanning the plurality of input signals and selecting a last input signal of the plurality of input signals as the output signal;
a memory function block, capable of recording an input sequence of the plurality of input signals;
a switch-back function block, capable of selecting the output signal from the plurality of input signals based on the input sequence, when the last input signal of the plurality of input signals disappears; and
a memory-reset function block, capable of sorting the input sequence when a non-output signal of the plurality of input signals disappears.

2. The system of claim 1, wherein the switch-back function block is capable of selecting a second to last input signal from the plurality of input signals as the output signal based on the input sequence, when the last input signal disappears.

3. The system of claim 1, wherein the memory-reset function block is capable of sorting the input sequence using an increasing/decreasing operation, when the non-output signal of the plurality of input signals disappears.

4. An HDMI switcher for receiving a plurality of input signals and selecting an output signal to a display device from the plurality of input signals, the switcher comprises:
at least one HDMI input interface;
a control unit, capable of receiving the plurality of input signals transformed from the HDMI input interfaces, and selecting the output signal, wherein the control unit further comprises:
a last-one function block, capable of clocked scanning the plurality of input signals and selecting a last input signal of the plurality of input signals as the output signal;
a memory function block, capable of recording an input sequence of the plurality of input signals;
a switch-back function block, capable of selecting the output signal from the plurality of input signals based on the input sequence, when the last input signal of the plurality of input signals disappears;
a memory-reset function block, capable of sorting the input sequence when a non-output signal of the plurality of input signals disappears; and
an HDMI output interface, capable of outputting the output signal chosen by the control unit to the display device

5. The HDMI switcher of claim 4, wherein the switch-back function block is capable of selecting a second to last input signal from the plurality of input signals as the output signal based on the input sequence, when the last input signal disappears.

6. The HDMI switcher of claim 4, wherein the memory-reset function block is capable of sorting the input sequence by an increasing/decreasing operation.
